(19) United States
(12) Patent Application Publication
(10) Pub. No.: US 2025/0205522 A1
(43) Pub. Date: Jun. 26, 2025

(54) MASK

(71) Applicant: Samsung Electronics Co., Ltd., Suwon-si (KR)

(72) Inventors: Jeeyong KIM, Suwon-si (KR); Hyojin KIM, Suwon-si (KR); Sanghoon LEE, Suwon-si (KR); Joonhyoung KIM, Suwon-si (KR); Sungjin CHO, Suwon-si (KR); Hyeongjoon SEO, Suwon-si (KR); Kisup LEE, Suwon-si (KR)

(21) Appl. No.: 19/077,825

(22) Filed: Mar. 12, 2025

Related U.S. Application Data
(63) Continuation of application No. PCT/KR2023/012571, filed on Aug. 24, 2023.

(30) Foreign Application Priority Data
Oct. 11, 2022 (KR) 10-2022-0129972
Nov. 4, 2022 (KR) 10-2022-0146522
Jan. 25, 2023 (KR) 10-2023-0009655

(51) Int. Cl. A62B 23/02; A62B 18/00; A62B 18/10

(52) U.S. Cl. CPC A62B 23/02; A62B 18/003; A62B 18/10

(57) ABSTRACT

A mask is provided. The mask includes a mask body allowing air to be introduced and discharged therethrough, a fan disposed at the rear of the mask body to generate a blowing force, a first filter disposed between the mask body and the fan, and configured to filter air intaken by the fan, and a second filter disposed at rear of the fan to cover at least a part of a face of the user. The second filter is configured to filter air intaken from an outside of the mask body during the user inhales, and filter air discharged toward the outside of the mask body during the user exhales.

### CROSS-REFERENCE TO RELATED APPLICATION(S)

This application is a continuation application, claiming priority under § 365(c), of an International application No. PCT/KR2023/012571, filed on Aug. 24, 2023, which is based on and claims the benefit of a Korean patent application number 10-2022-0129972, filed on Oct. 11, 2022, in the Korean Intellectual Property Office, of a Korean patent application number 10-2022-0146522, filed on Nov. 4, 2022, in the Korean Intellectual Property Office, and of a Korean patent application number 10-2023-0009655, filed on Jan. 25, 2023, in the Korean Intellectual Property Office, the disclosure of each of which is incorporated by reference herein in its entirety.

### BACKGROUND

### 1. Field

The disclosure relates to a mask having an improved structure.

### 2. Description of Related Art

A mask is an item that covers the mouth and nose to block substances such as germs or dust.

In general, the mask may include a filter to protect the respiratory system from particulate harmful substances, such as yellow dust and fine dust, and various infectious agents. However, the higher the filter rating of the mask, the more difficult it may be for a user to breathe. In addition, when the filter is contaminated, the function of the mask may be lowered, making it difficult to reuse the mask.

Recently, masks that may control the airflow inside and be used multiple times are being developed. These masks may include a blowing device provided to forcibly circulate air.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a mask with improved usability.

Another aspect of the disclosure is to provide a mask that allows smooth breathing for a user.

Another aspect of the disclosure is to provide a mask with consideration for a user breathing pattern.

Another aspect of the disclosure is to provide a mask that is lightweight.

Additional aspects will be set forth in part in the description which follows and, in part, will be apparent from the description, or may be learned by practice of the presented embodiments.

In accordance with an aspect of the disclosure, a mask is provided. The mask may include: a mask body allowing air to be introduced and discharged therethrough; a fan disposed at a rear of the mask body to generate a blowing force; a first filter disposed between the mask body and the fan and configured to filter air intaken by the fan; and a second filter disposed at a rear of the fan to cover at least a part of a face of a user. The second filter may be configured to filter air intaken from an outside of the mask body when the user inhales and filter air discharged toward the outside of the mask body when the user exhales.

The mask may further include a suction module including the first filter and the fan. The mask may further include a discharge module configured to discharge air passed through the second filter to the outside of the mask body.

When the user inhales, air outside of the mask body may be allowed to flow toward the face of the user by passing through the mask body, the first filter, the fan, and the second filter. When the user inhales, air outside of the mask body may be allowed to flow toward the face of the user by passing through the mask body and the second filter.

When the user exhales, air between the second filter and the face of the user may be allowed to flow toward the outside of the mask body by passing through the second filter, the discharge module, and the mask body. When the user exhales, air between the second filter and the face of the user may be allowed to flow toward the outside of the mask body by passing through the second filter and the mask body.

The mask body may be flexible.

The mask may further include an exhaust valve configured to allow an airflow toward the outside of the mask body.

The first filter and the fan may be covered by the mask body and the second filter.

The suction module may further include an opening through which air passed through the first filter and the fan is discharged. The second filter may further include an inlet portion provided to correspond to the opening of the suction module and provided to receive the air discharged through the opening of the suction module.

The suction module may further include a filter mounting portion formed along a circumference of the opening. The second filter may further include a coupling portion detachably coupled to the filter mounting portion of the suction module.

The discharge module may further include an opening through which air passed through the second filter is introduced. The second filter may further include an outlet portion provided to correspond to the opening of the discharge module and provided to discharge air toward the opening of the discharge module.

The discharge module may further include a filter mounting portion formed along a circumference of the opening. The second filter may further include a coupling portion detachably coupled to the filter mounting portion of the discharge module.

The mask body may include a fabric material.

The second filter may be configured to block droplets.

The mask may further include a holder provided on a rear side of the mask body. The second filter may further include a holder coupling portion configured to be detachably coupled to the holder.

The discharge module may further include a controller provided to control an operation of the fan of the suction module. The may further include a connecting portion provided to connect the suction module and the discharge module and guide a wire of the suction module to the controller.

The mask may further include a blowing device disposed between the mask body and the second filter, and including the suction module and the discharge module. The blowing device may include a spacer protruding rearward from at least one of the suction module or the discharge module to prevent the blowing device and the second filter from being in close contact with each other.

The spacer may be configured to form a path through which air is allowed to flow between the blowing device and the second filter.

In accordance with another aspect of the disclosure, a mask is provided. The mask may include: a mask body; a blowing device disposed at a rear of the mask body; and a first filter disposed at a rear of the blowing device and allowing air to be introduced and discharged therethrough in response to a user breathing. The blowing device may include a suction module configured to discharge air toward the first filter. The suction module may include a fan configured to generate a blowing force, and a second filter disposed between the mask body and the fan to filter outside air intaken by the fan. The blowing device may include an exhaust module disposed to discharge air intaken from the first filter to the outside.

When the user inhales, outside air may be allowed to flow toward the face of the user by passing through the mask body, the suction module, and the first filter. When the user inhales, outside air may be allowed to flow toward the face of the user by passing through the mask body and the first filter.

When the user exhales, air between the first filter and the face of the user may be allowed to flow toward the outside of the mask body by passing through the first filter, the discharge module, and the mask body. When the user exhales, air between the first filter and the face of the user may be allowed to flow toward the outside of the mask body by passing through the first filter and the mask body.

The mask body may include a fabric material.

The first filter may include a first coupling portion configured to be detachably coupled to a rear surface of the mask body. The first filter may further include a second coupling portion configured to be detachably coupled to the blowing device.

The blowing device may further include a spacer that forms a gap between the blowing device and the first filter. The spacer may protrude from at least one of the suction module or the discharge module toward the first filter.

The spacer may be a first spacer, and the blowing device may further include a second spacer that forms a gap between the blowing device and the mask body. The second spacer may protrude from at least one of the suction module or the discharge module toward the mask body.

According to an embodiment of the disclosure, a mask with improved usability can be provided.

According to an embodiment of the disclosure, a mask that allows smooth breathing for a user can be provided.

According to an embodiment of the disclosure, a mask with consideration for a user breathing pattern can be provided.

According to an embodiment of the disclosure, a lightweight mask can be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an example of a mask according to an embodiment of the disclosure;

FIG. 2 is a perspective view of the mask shown in FIG. 1 viewed in a different direction according to an embodiment of the disclosure;

FIG. 3 is an exploded view of an example of a mask according to an embodiment of the disclosure;

FIG. 4 is an exploded view of the mask shown in FIG. 3, which is viewed in a different direction according to an embodiment of the disclosure;

FIG. 5 is an exploded view of an example of a mask according to an embodiment of the disclosure;

FIG. 6 is an exploded view of an example of a blowing device according to an embodiment of the disclosure;

FIG. 7 is a plan view of an example of a mask according to an embodiment of the disclosure;

FIG. 8 is a view illustrating airflow during intake of the mask shown in FIG. 7 according to an embodiment of the disclosure;

FIG. 9 is a view illustrating airflow during exhaust of the mask shown in FIG. 7 according to an embodiment of the disclosure;

FIG. 10 is an exploded view of an example of a mask according to an embodiment of the disclosure;

FIG. 11 is an exploded view of an example of a mask according to an embodiment of the disclosure;

FIG. 12 is a rear view of an example of a blowing device according to an embodiment of the disclosure;

FIG. 13 is a rear view of an example of a blowing device according to an embodiment of the disclosure;

FIG. 14 is a rear view of an example of a blowing device according to an embodiment of the disclosure;

FIG. 15 is a rear view of an example of a blowing device according to an embodiment of the disclosure;

FIG. 16 is a plan view of an example of a mask according to an embodiment of the disclosure;

FIG. 17 is a view illustrating airflow during intake of the mask shown in FIG. 16 according to an embodiment of the disclosure;

FIG. 18 is a view illustrating airflow during exhaust of the mask shown in FIG. 16 according to an embodiment of the disclosure;

FIG. 19 is a plan view of an example of a mask according to an embodiment of the disclosure; and

FIG. 20 is a plan view of an example of a mask according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The same reference numerals or signs shown in the drawings of the disclosure indicate elements or components performing substantially the same function.

The terms used herein are used to describe the embodiments and are not intended to limit and/or restrict the disclosure. In this disclosure, the terms “comprising”, “including”, “having”, and the like are used to specify features, numbers, steps, operations, elements, components, or combinations thereof, but do not preclude the presence or addition of one or more of the features, elements, steps, operations, elements, components, or combinations thereof.

When a part is referred to as being “connected to” another part, it may not only be directly connected to the other part but may in addition be indirectly connected to the other part. Similarly, when a part is referred to as being “coupled to” another part, it may not only be directly coupled to the other part but may in addition be indirectly coupled to the other part.

It will also be understood that when a certain component is referred to as being “on” or “over” another component, it may be directly on the other component or intervening components may also be present.

It may be understood that, although the terms first, second, etc., may be used herein to describe various elements, but elements are not limited by these terms. These terms are only used to distinguish one element from another element. For example, without departing from the scope of the disclosure, a first element may be termed as a second element, and a second element may be termed as a first element.

The term of “and/or” includes a plurality of combinations of relevant items or any one item among a plurality of relevant items.

The terms of “˜part”, “˜module” and “˜member” may be implemented in hardware or software. In some embodiments, a plurality of “˜parts”, “˜modules” and “˜members” may be implemented as a single component. In some embodiments, a single “˜part”, “˜module” and “˜member” may include multiple components.

The terms “front-rear direction”, “frontward”, “backward”, “lateral direction”, “left-right direction”, “right”, “left”, “upper-lower direction”, “upper”, “lower”, etc. are defined based on the drawings, and the shapes and positions of the components are not limited by the terms. For example, an X direction may be defined as a front-rear direction. For example, a Y direction may be defined as a left-right direction (lateral direction). For example, a Z direction may be defined as an upper-lower direction. For example, a +X direction may be defined as a frontward direction, and a −X direction may be defined as a backward direction. For example, the +Y direction may be defined as a right direction, and the −Y direction may be defined as a left direction. For example, the +Z direction may be defined as an upward direction, and the −Z direction may be defined as a downward direction.

Meanwhile, in this document, an inside of a mask 1 may refer to a space between the mask 1 and a user's face when the user is wearing the mask 1. The inside of the mask 1 may be referred to as a breathing space.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, embodiments according to the disclosure may be described in detail with reference to the accompanying drawings.

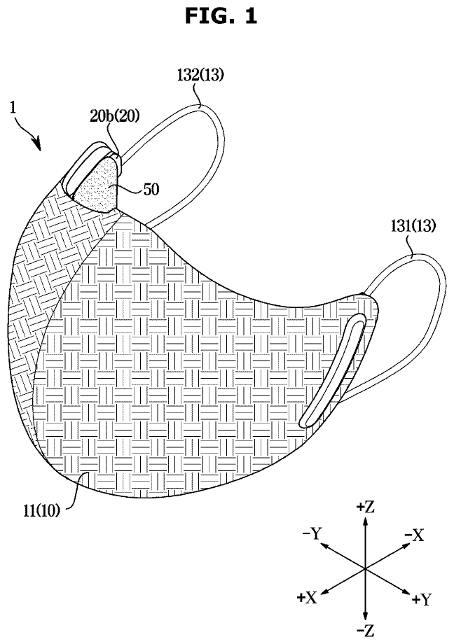

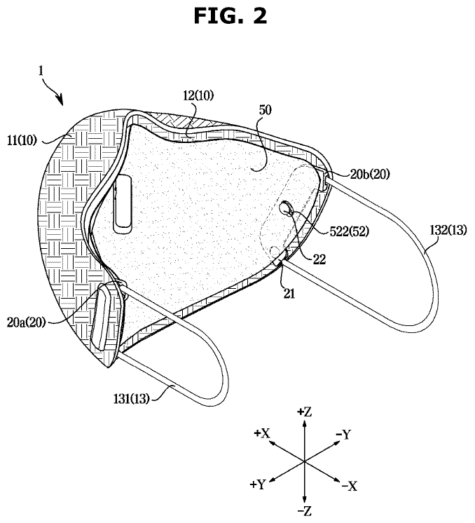

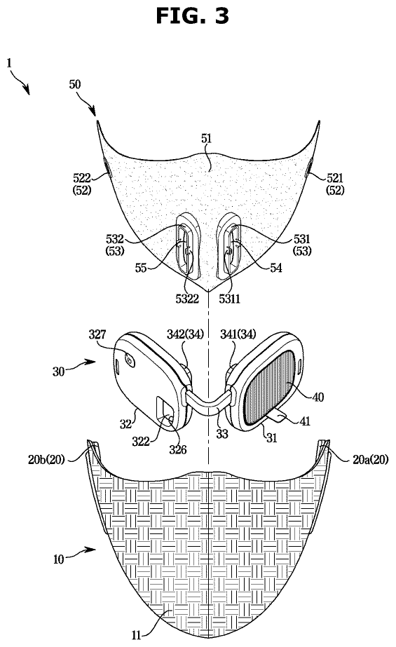

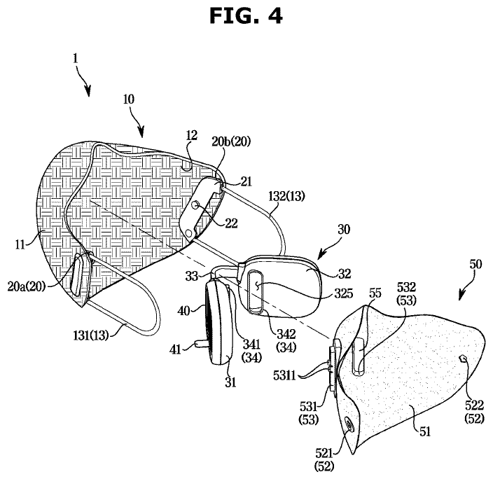

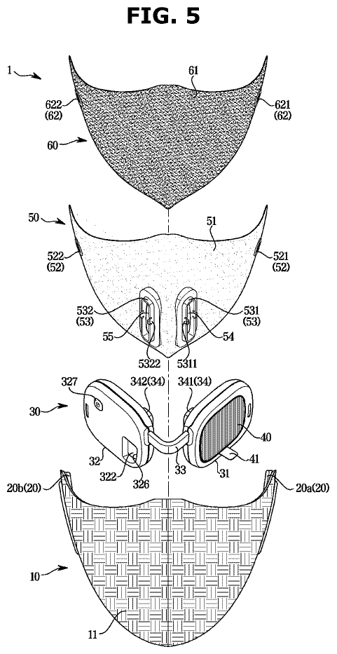

FIG. 1 is a perspective view of an example of a mask according to an embodiment of the disclosure. FIG. 2 is a perspective view of the mask shown in FIG. 1 from a different direction according to an embodiment of the disclosure. FIG. 3 is an exploded view of an example of a mask according to an embodiment of the disclosure. FIG. 4 is an exploded view of the mask shown in FIG. 3, which is viewed in a different direction according to an embodiment of the disclosure. FIG. 5 is an exploded view of an example of a mask according to an embodiment of the disclosure.

Referring to FIGS. 1 to 5, a mask 1 may include a mask body 10. The mask body 10 may form at least a part of an external appearance of the mask 1. For example, the mask body 10 may form a front appearance of the mask 1.

A front surface 11 of the mask body 10 may be exposed to the outside. The front surface 11 of the mask body 10 may be provided to form a front surface of the mask 1.

A rear surface 12 of the mask body 10 may be positioned opposite the front surface 11 of the mask body 10. The rear surface 12 of the mask body 10 may be provided to face a user's face.

Components of the mask 1 may be detachably mounted on the mask body 10. For example, a blowing device 30 to be described below may be detachably mounted on the mask body 10. For example, a filter 50 or 60 to be described below may be detachably mounted on the mask body 10.

The mask body 10 may be provided to allow air to be introduced and discharged therethrough. For example, the mask body 10 may be provided to allow a flow of external air. For example, the mask body 10 may be provided such that air passing through at least one filter 40 and/or 50 to flow. For example, the mask bout body 10 may be provided to filter out foreign substances in the air passing through the mask body 10.

For example, the mask body 10 may be provided to be flexible. For example, the mask body 10 may include a fabric material.

In related art, a mask body forming an external appearance of a mask may be heavy and rigid by being formed of an injection molding material. In comparison, the mask body 10 may be formed of a material that allows air to flow in and out and may be lightweight and flexible. Accordingly, the portability of the mask body 10 may be improved and storage of the mask body 10 may be facilitated.

The mask body 10 may include a fixing portion that may be fixed to at least a part of a user's body. A user may easily wear the mask through the fixing portion.

For example, the fixing portion may include an ear hook portion 13. The ear hook portion 13 may be provided to be hung on a user's ear. The ear hook portion 13 may include a left ear hook portion 131 provided to be hung on a user's left ear. The ear hook portion 13 may include a right ear hook portion 132 provided to be hung on a user's right ear.

For example, the ear hook portion 13 may be detachably mounted on the mask body 10. However, it is not limited thereto, and the ear hook portion 13 may be integrally formed with the mask body 10.

For example, the ear hook portion 13 may be detachably coupled to a holder 20 to be described below. For example, the ear hook portion 13 may be provided to be fixed to the holder 20. For example, the ear hook portion 13 may be provided as one component of the holder 20. For example, the ear hook portion 13 may be integrally formed with the holder 20.

The mask body 10 may be referred to as an outer cover.

The mask 1 may include the holder 20. The holder 20 may be provided at the rear of the mask body 10. The holder 20 may be provided on the rear surface 12 of the mask body 10. The holder 20 may be provided as one component of the mask body 10. For example, the holder 20 may be integrally formed with the mask body 10. However, it is not limited thereto, and the holder 20 may be provided as a separate component separated from the mask body 10. The holder 20 may be detachably attached to the rear surface 12 of the mask body 10.

The holder 20 may be provided to hold the components of the mask 1. The holder 20 may allow the components of the mask 1 to be fixed to the mask body 10.

For example, the holder 20 may be provided to hold the filter 50. The filter 50 may be detachably coupled to the holder 20. The filter 50 may be detachably mounted to the holder 20. Meanwhile, although not shown in the drawing, the holder 20 may, for example, be provided to hold the blowing device 30.

For example, the holder 20 may include a holder body 21 and a filter coupling portion 22 formed on the holder body 21. The holder body 21 may be provided to form the external appearance of the holder 20. The filter 50 may be detachably coupled to the filter coupling portion 22. For example, the filter coupling portion 22 may extend toward the filter 50 from the holder body 21. For example, the filter coupling portion 22 may protrude backward from the holder body 21. However, it is not limited thereto. The shape of the filter coupling portion 22 is not limited, as long as the filter coupling portion 22 is provided to be coupled to the filter 50.

For example, the holder 20 may be provided to include at least one holder portion 20a and 20b. However, it should be understood that the holder 20 may be provided as a single holder portion.

For example, the holder 20 may include a first holder portion 20a and a second holder portion 20b. The first holder portion 20a may be provided to correspond to a left side portion of the filter 50. For example, the second holder portion 20b may be provided to correspond to a right side portion of the filter 50. For example, the first holder portion 20a and the second holder portion 20b may be arranged symmetrically with respect to the vertical center line of the mask body 10. The first holder portion 20a and the second holder portion 20b may be arranged in the left-right direction (Y direction). In the drawing, the first holder portion 20a is illustrated as being located on the left side of the second holder portion 20b, but it is not limited thereto, and the first holder portion 20a may be located on the right side of the second holder portion 20b. As long as the first holder portion 20a and the second holder portion 20b can each hold a filter 50, the arrangement direction of the first holder portion 20a and the second holder portion 20b is not limited. For example, the first holder portion 20a and the second holder portion 20b may be arranged in the upper-lower direction.

Each of the first holder portion 20a and the second holder portion 20b may include a holder body 21 and a filter coupling portion 22.

The mask 1 may include the blowing device 30. The blowing device 30 may generate a blowing force. The blowing device 30 may be provided to forcibly flow air. The blowing device 30 may be provided to generate airflow inside the mask 1. The blowing device 30 may facilitate the flow of air inside the mask 1. For example, the blowing device 30 may draw in external air into the mask 1 during a user's inhalation. For example, the blowing device 30 may discharge air inside the mask 1 to the outside of the mask 1 during a user's exhalation.

The blowing device 30 may be disposed at the rear of the mask body 10. The blowing device 30 may be disposed at the front of the filter 50. The blowing device 30 may be disposed between the mask body 10 and the filter 50.

The blowing device 30 may be detachably mounted on the mask body 10. For example, the blowing device 30 may be detachably mounted on the rear side of the mask body 10. For example, the blowing device 30 may be detachably coupled to the rear surface 12 of the mask body 10.

The blowing device 30 may be detachably mounted on the filter 50. For example, the blowing device 30 may include a filter mounting portion 34. The filter mounting portion 34 of the blowing device 30 may be detachably coupled to a blower coupling portion 53 of the filter 50 to be described below.

For example, the filter mounting portion 34 may be provided as at least one unit thereof. For example, the filter mounting portion 34 may include a first mounting portion 341 and a second mounting portion 342. For example, the first mounting portion 341 of the filter mounting portion 34 may correspond to a first blowing device coupling portion 531 of the blowing device coupling portion 53 to be described below. The first mounting portion 341 may be detachably coupled to the first blowing device coupling portion 531. For example, the second mounting portion 342 of the filter mounting portion 34 may correspond to a second blowing device coupling portion 532 of the blowing device coupling portion 53 to be described below. The second mounting portion 342 may be detachably coupled to the second blowing device coupling portion 532.

The blowing device 30 may be covered by the mask body 10. The blowing device 30 may not protrude outward from the mask body 10. The blowing device 30 may be covered by the filter 50. The blowing device 30 may not protrude outward from the filter 50. The front of the blowing device 30 may be covered by the mask body 10, and the rear of the blowing device 30 may be covered by the filter 50. When the mask 1 is worn by a user, the blowing device 30 may not be exposed to the outside of the mask 1. For example, as the blowing device 30 is not exposed to the front of the mask 1, the front surface of the mask 1 (i.e., the front surface 11 of the mask body 10 may maintain a neat appearance. For example, as the blowing device 30 is not exposed to a rear of the mask 1, the rear surface of the mask 1 (i.e., the rear surface of the filter 50 may maintain a neat appearance. As a result, an aesthetics of the mask 1 may be improved.

For example, the blowing device 30 may include at least one blowing module. For example, the blowing device 30 may include a first blowing module 31 and a second blowing module 32. However, the disclosure is not limited thereto, and the first blowing module 31 and the second blowing module 32 may be provided as a single component.

One of the first blowing module 31 and the second blowing module 32 may be provided to draw in outside air. The other one of the first blowing module 31 and the second blowing module 32 may be provided to discharge air inside the mask 1 to the outside. The first blowing module 31 and the second blowing module 32 may be arranged laterally. The first blowing module 31 and the second blowing module 32 may be arranged in a left-right direction. The first blowing module 31 may be arranged between the mask body 10 and the second filter 50. The second blowing module 32 may be arranged between the mask body 10 and the second filter 50.

For example, the first blowing module 31 may be provided to draw in outside air. The first blowing module 31 may allow outside air to be introduced into the mask 1. The first blowing module 31 may draw in air from outside of the mask 1 and discharge the air toward the user's face.

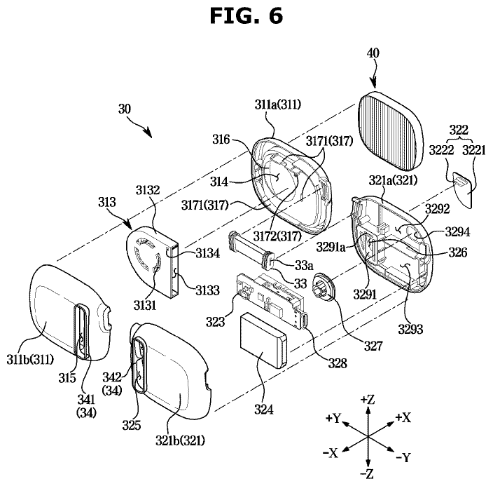

The first blowing module 31 may include a fan 3131 (see FIG. 6) that generates blowing force. The first blowing module 31 may include a first filter 40 arranged between the mask body 10 and the fan 3131 to filter outside air.

The first blowing module 31 may be referred to as a suction module 31.

For example, the second blowing module 32 may be provided to discharge air from the inside of the mask 1 to the outside of the mask 1. The second blowing module 32 may be provided to discharge user's exhaled air to the outside of the mask 1.

For example, the second blowing module 32 may be arranged on a lateral side of the first blowing module 31. In the drawing, the second blowing module 32 is illustrated as being arranged on the right side of the first blowing module 31, but the disclosure is not limited thereto, and the second blowing module 32 may also be arranged on the left side of the first blowing module 31.

The second blowing module 32 may be referred to as a discharge module 32.

The blowing device 30 may include a connecting portion 33. The connecting portion 33 may be provided between the first blowing module 31 and the second blowing module 32. The connecting portion 33 may be provided to connect the first blowing module 31 and the second blowing module 32. The connecting portion 33 may be provided to guide components of the first blowing module 31 to the second blowing module 32. The connecting portion 33 may be provided to guide components of the second blowing module 32 to the first blowing module 31. For example, a wire (not shown) of the first blowing module 31 may be provided to pass through the connecting portion 33 and then enter the second blowing module 32. For example, a wire (not shown) of the fan unit 313 (see FIG. 6) may be provided to pass through the connecting portion 33 and then enter the second blowing module 32.

The blowing device 30 may be referred to as a blower assembly.

The mask may include a first filter 40. The first filter 40 may be provided to filter air drawn by the blowing device 30. The first filter 40 may be provided to filter air drawn by the fan 3131 of the blowing device 30. The first filter 40 may be provided to filter introduced into the first blowing module 31.

The first filter 40 may be provided to filter air introduced from the outside of the mask body 10. The first filter 40 may be provided to filter air that has passed through the mask body 10. The first filter 40 may be provided to filter external air.

For example, the first filter 40 may be provided to filter out foreign substances such as fine dust, exhaust gas and viruses contained in air. For example, the first filter 40 may be provided to block droplets. For example, the first filter 40 may include a HEPA filter. However, it is not limited thereto, and the first filter 40 may include various filters.

The first filter 40 may be arranged at the rear of the mask body 10. The first filter 40 may be arranged at the front of the fan 3131. The first filter 40 may be arranged between the mask body 10 and the fan 3131. The first filter 40 may be covered by the mask body 10 and the second filter 50.

The first filter 40 may be provided as a component of the blowing device 30. The first filter 40 may be provided as a component of the first blowing module 31. However, the disclosure is not limited thereto, and the first filter 40 may be provided as a separate component from the blowing device 30 and may be detachably coupled to the blowing device 30.

For example, the first filter 40 may include a gripping portion 41 that is grippable by a user. A user may attach the first filter 40 to the blowing device 30 while holding the gripping portion 41 of the first filter 40. A user may separate the first filter 40 from the blowing device 30 while holding the gripping portion 41 of the first filter 40.

For example, the gripping portion 41 may protrude from the blowing device 30 while the first filter 40 is mounted on the blowing device 30. For example, the gripping portion 41 may be formed of a flexible material. For example, the gripping portion 41 may be provided to be foldable while the blowing device 30 is mounted on the mask body 10.

The mask 1 may include a second filter 50. The second filter 50 may be provided to filter at least one of air drawn into the mask 1 or air discharged to the outside of the mask 1.

For example, the second filter 50 may be provided to filter air drawn into the mask 1 by the blowing force of the blowing device 30. For example, the second filter 50 may be provided to filter air that has passed through the blowing device 30. For example, the second filter 50 may be provided to filter air that has passed through the first filter 40. For example, the second filter 50 may be provided to filter air that has passed through the mask body 10. For example, the second filter 50 may be provided to filter air that a user exhales.

The second filter 50 may be provided to allow air to flow in and out in response to a user's breathing. The second filter 50 may be provided to filter air drawn from the outside of the mask body 10 when a user inhales. The second filter 50 may be provided to filter air discharged toward the outside of the mask body 10 when a user exhales. Details thereof may be described below.

For example, the second filter 50 may be provided to filter out foreign substances such as fine dust, exhaust gas and viruses contained in air. For example, the second filter 50 may be provided to block droplets. The second filter 50 may include various filters.

The second filter 50 may be disposed at the rear of the mask body 10. The second filter 50 may be disposed at the rear of the blowing device 30. The second filter 50 may be disposed at the rear of the first filter 40. The second filter 50 may be disposed at the rear of the fan 3131. The second filter 50 may be disposed at the front of a user's face. The second filter 50 may be disposed between the blowing device 30 and a user's face.

The second filter 50 may be provided to cover at least a part of a user's face. For example, the second filter 50 may be provided to cover a user's nose, cheeks and chin.

The second filter 50 may include a filter body 51. The filter body 51 may form an external appearance of the second filter 50. The filter body 51 may be provided to cover a user's face. For example, the filter body 51 may have a size substantially corresponding to that of the mask body 10.

The filter body 51 may be provided to allow air to flow in and out. The filter body 51 may be provided to filter out foreign substances contained in air passing through the second filter 50.

The second filter 50 may include the holder coupling portion 52. The holder coupling portion 52 may be detachably coupled to the holder 20. The holder coupling portion 52 may be mounted on the holder 20. The second filter 50 may be fixed to the mask body 10 as the holder coupling portion 52 is coupled to the holder 20. However, it is not limited thereto, and the second filter 50 may be detachably coupled directly to the mask body 10 without being coupled to the holder 20.

For example, the holder coupling portion 52 may be provided as at least one unit thereof. For example, the holder coupling portion 52 may include a first holder coupling portion 521 and a second holder coupling portion 522.

The first holder coupling portion 521 may be provided to correspond to the first holder portion 20a. The first holder coupling portion 521 may be detachably coupled to a filter coupling portion 22 of the first holder portion 20a. The first holder coupling portion 521 may be mounted on the filter coupling portion 22 of the first holder portion 20a. The first holder coupling portion 521 may be formed on the left side portion of the holder body 51.

For example, the first holder coupling portion 521 may include a hole that engages with the filter coupling portion 22 of the first holder portion 20a. For example, the first holder coupling portion 521 may include a hole formed to pass through the filter body 51. However, it is not limited thereto. The shape of the first holder coupling portion 521 is not limited, as long as the first holder coupling portion 521 is detachably coupled to the first holder portion 20a.

The second holder coupling portion 522 may be provided to correspond to the second holder portion 20b. The second holder coupling portion 522 may be detachably coupled to a filter coupling portion 22 of the second holder portion 20b. The second holder coupling portion 522 may be mounted on the filter coupling portion 22 of the second holder portion 20b. The second holder coupling portion 522 may be formed on the right side portion of the holder body 51.

For example, the second holder coupling portion 522 may include a hole that engages with the filter coupling portion 22 of the second holder portion 20b. For example, the second holder coupling portion 522 may include a hole formed to pass through the filter body 51. However, it is not limited thereto. The shape of the second holder coupling portion 522 is not limited, as long as the second holder coupling portion 522 is detachably coupled to the second holder portion 20b.

The holder coupling portion 52 may be referred to as a coupling portion 52.

The second filter 50 may include a blowing device coupling portion 53. The blowing device coupling portion 53 may be detachably coupled to the blowing device 30. The blowing device coupling portion 53 may be detachably mounted to the blowing device 30.

The blowing device coupling portion 53 of the second filter 50 may be provided to correspond to the filter mounting portion 34 of the blowing device 30. The blowing device coupling portion 53 of the second filter 50 may be detachably coupled to the filter mounting portion 34 of the blowing device 30.

For example, the blowing device coupling portion 53 may be provided as at least one unit thereof. For example, the blowing device coupling portion 53 may include a first blowing device coupling portion 531 and a second blowing device coupling portion 532.

For example, the first blowing device coupling portion 531 may correspond to the first mounting portion 341 of the filter mounting portion 34. The first blowing device coupling portion 531 may be detachably coupled to the first mounting portion 3411. The first blowing device coupling portion 531 may be formed around an inlet portion 54 to be describe below. The first blowing device coupling portion 531 may be formed along a circumference of the inlet portion 54.

For example, the first blowing device coupling portion 531 may include a first catch portion 5311. For example, the first catch portion 5311 may be provided to catch on the first mounting portion 341 of the filter mounting portion 34. For example, while the blowing device 30 and the second filter 50 are coupled to each other, the first catch portion 5311 may be provided to prevent the blowing device 30 and the second filter 50 from being separated. For example, the first catch portion 5311 may protrude toward the first mounting portion 341 of the filter mounting portion 34. For example, the first catch portion 5311 may protrude forward.

For example, the second blowing device coupling portion 532 may correspond to the second mounting portion 342 of the filter mounting portion 34. The second blowing device coupling portion 532 may be detachably coupled to the second mounting portion 342. The second blowing device coupling portion 532 may be formed around an outlet portion 55 to be described below. The second blowing device coupling portion 532 may be formed along a circumference of the outlet portion 55.

For example, the second blowing device coupling portion 532 may include a second catch portion 5322. For example, the second catch portion 5322 may be provided to catch on the second mounting portion 342 of the filter mounting portion 34. For example, while the blowing device 30 and the second filter 50 are coupled to each other, the second catch portion 5322 may be provided to prevent the blowing device 30 and the second filter 50 from being separated. For example, the second catch portion 5322 may protrude toward the second mounting portion 342 of the filter mounting portion 34. For example, the second catch portion 5322 may protrude forward.

The second filter 50, provided with the blowing device coupling portion 53, may be more stably fixed to the blowing device 30. In addition, while the second filter 50 and the blowing device 30 are stably coupled, air flow between the second filter 50 and the blowing device 30 may be prevented from leaking.

The blowing device coupling portion 53 may be referred to as a coupling portion 53.

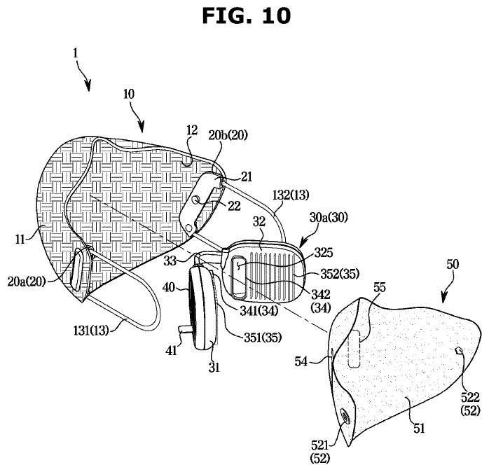

However, the blowing device coupling portion 53 may be provided to be omitted from the second filter 50 (see reference numeral 50 in FIG. 10.

The second filter 50 may include an inlet portion 54. The inlet portion 54 may be provided to receive air flowing out from the blowing device 30. For example, the inlet portion 54 may be provided to receive air flowing out from the first blowing module 31 of the blowing device 30. For example, the inlet portion 54 may be arranged to correspond to an opening 315 (see FIG. 6) of the first blowing module 31 to receive air flowing out through the opening 315 of the first blowing module 31.

Air flowing out from the blowing device 30 may pass through the inlet portion 54 of the second filter 50. Air passing through the inlet portion 54 of the second filter 50 may flow toward the user's face. Air passing through the inlet portion 54 of the second filter 50 may flow into the space between the second filter 50 and the user's face.

For example, the inlet portion 54 may be defined as an area of the filter body 51 corresponding to the opening 315 of the first blowing module 31. For example, the inlet portion 54 may be provided as a part of the filter body 51. Accordingly, the air flowing out from the blowing device 30 may be filtered while passing through the inlet portion 54. For example, foreign substances, droplets, etc. contained in the air may be filtered out by the inlet portion 54. However, the disclosure is not limited thereto, and the inlet portion 54 may be provided as an opening to smoothly receive the air flowing out from the blowing device 30.

The second filter 50 may include an outlet portion 55. The outlet portion 55 may be provided to discharge air toward the blowing device 30. For example, the outlet portion 55 may be provided to discharge air toward the second blowing module 32 of the blowing device 30. For example, the outlet portion 55 may be arranged to correspond to an opening 325 (see FIG. 6) of the second blowing module 32 to discharge air toward the opening 325 of the second blowing module 32.

The air in the space between the second filter 50 and the user's face may pass through the outlet portion 55 of the second filter 50. The air that has passed through the outlet portion 55 of the second filter 50 may flow toward the blowing device 30. The air that has passed through the outlet portion 55 of the second filter 50 may flow to the second blowing module 32.

For example, the outlet portion 55 may be defined as an area of the filter body 51 corresponding to the opening 325 of the second blowing module 32. For example, the outlet portion 55 may be provided as a part of the filter body 51. Accordingly, the air that is discharged from an area between the user's face and the second filter 50 to the blowing device 30 may be filtered while passing through the outlet portion 55. For example, foreign substances, droplets, etc. contained in the air may be filtered out by the outlet portion 55. However, the disclosure is not limited thereto, and the outlet portion 55 may be provided as an opening to smoothly discharge air present between the user's face and the second filter 50.

Referring to FIGS. 2 to 4, the mask 1 is illustrated as including a single second filter 50, but the disclosure is not limited thereto. The second filter 50 may be provided in plural. For example, the plurality of second filters 50 may be arranged in the front-rear direction.

The second filter 50 may be referred to as an inner cover.

Meanwhile, as described above, the ordinal numbers such as “first” and “second” do not limit the configuration. The first filter and the second filter may be referred as the second filter 40 and the first filter 50, respectively.

Referring to FIG. 5, the mask 1 may further include a third filter 60. The third filter 60 may be arranged in a front-rear direction with respect to the second filter 50. The third filter 60 may be arranged at the rear of the second filter 50. The third filter may be arranged adjacent to the user's face. The third filter 60 may be arranged between the second filter 50 and the user's face. The third filter 60 may be arranged to be omitted from the mask 1.

The third filter 60 may be provided to filter air that has passed through the second filter 50. The third filter 60 may be provided to filter air that a user exhales.

The third filter 60 may include a filter body 61. The filter body 61 may form an external appearance of the third filter 60. The filter body 61 may be provided to cover the user's face. For example, the filter body 61 may be provided with a size that roughly corresponds to that of the filter body 51 of the second filter 50.

The filter body 61 may be provided to allow air to be introduced and discharged therethrough. The filter body 61 may be provided to filter out foreign substances contained in air passing through the third filter 60.

The third filter 60 may include a holder coupling portion 62. The holder coupling portion 62 may be detachably coupled to the holder 20. The holder coupling portion 62 may be mounted on the holder 20. The third filter 60 may be fixed to the mask body 10 as the holder coupling portion 62 is coupled to the holder 20. However, the disclosure is not limited thereto, and the third filter 60 may be detachably coupled directly to the mask body 10 without being coupled to the holder 20.

For example, the holder coupling portion 62 may be provided as at least one unit thereof. For example, the holder coupling portion 62 may include a third holder coupling portion 621 and a fourth holder coupling portion 622.

The third holder coupling portion 621 may be provided to correspond to the first holder portion 20a. The third holder coupling portion 621 may be detachably coupled to the filter coupling portion 22 of the first holder portion 20a. The third holder coupling portion 621 may be mounted on the filter coupling portion 22 of the first holder portion 20a. The third holder coupling portion 621 may be formed on the left side of the holder body 61.

For example, the first holder coupling portion 521 of the second filter 50 and the third holder coupling portion 621 of the third filter 60 may be sequentially coupled to the filter coupling portion 22 of the first holder portion 20a.

For example, the third holder coupling portion 621 may include a hole that engages with the filter coupling portion 22 of the first holder portion 20a. For example, the third holder coupling portion 621 may include a hole formed to pass through the filter body 61. However, the disclosure is not limited thereto, and the shape of the third holder coupling portion 621 is not limited as long as the third holder coupling portion 621 can be detachably coupled to the first holder portion 20a.

The fourth holder coupling portion 622 may be provided to correspond to the second holder portion 20b. The fourth holder coupling portion 622 may be detachably coupled to the filter coupling portion 22 of the second holder portion 20b. The fourth holder coupling portion 622 may be mounted on the filter coupling portion 22 of the second holder portion 20b. The fourth holder coupling portion 622 may be formed on the right side of the holder body 62.

For example, the second holder coupling portion 522 of the second filter 50 and the fourth holder coupling portion 622 of the third filter 60 may be sequentially coupled to the filter coupling portion 22 of the second holder portion 20b.

For example, the fourth holder coupling portion 622 may include a hole that engages with the filter coupling portion 22 of the second holder portion 20b. For example, the fourth holder coupling portion 622 may include a hole formed to pass through the filter body 61. However, the disclosure is not limited thereto, and the shape of the fourth holder coupling portion 622 is not limited thereto as long as the fourth holder coupling portion 622 may be detachably coupled to the second holder portion 20b.

Referring to FIG. 5, the mask 1 is illustrated as including a single third filter 60, but the disclosure is not limited thereto. The third filter 60 may be provided in plural. For example, the plurality of third filters 60 may be arranged in the front-rear direction.

FIG. 6 is an exploded view of an example of a blowing device according to an embodiment of the disclosure.

Referring to FIG. 6, the blowing device 30 may include a first blowing module 31 and a second blowing module 32.

The first blowing module 31 may include a first case 311 forming the external appearance of the first blowing module 31. The first case 311 may be provided to accommodate components of the first blowing module 31.

For example, the first case 311 may include a first front case 311a provided to face the mask body 10. For example, the first case 311 may include a first rear case 311b provided to face a user's face. The first front case 311a and the first rear case 311b may be detachably coupled.

The first case 311 may include a filter mounting portion 316 to which the first filter 40 is detachably mounted. For example, the filter mounting portion 316 may be formed on the front case 311a. For example, the filter mounting portion 316 may be formed adjacent to a first opening 314.

The first case 311 may include a fan unit mounting portion 317 to which the fan unit 313 is detachably mounted. For example, the fan unit mounting portion 317 may be formed inside the first case 311.

The first blowing module 31 may include the first opening 314 through which air flows into the first blowing module 31. External air may flow into the first blowing module 31 through the first opening 314. Air passing through the mask body 10 may flow toward the fan unit 313 through the first opening 314. The first opening 314 may be provided to correspond to the first filter 40. The first opening 314 may be formed in the first case 311. For example, the first opening 314 may be formed in the first front case 311a.

The first blowing module 31 may include a second opening 315 through which air flows out of the first blowing module 31. Air passing through the first blowing module 31 may flow out of the blowing device 30 through the second opening 315. Air that has passed through the first filter 40 and the fan 3131 may flow out of the blowing device 30 through the second opening 315. Air discharged through the second opening 315 may flow toward the second filter 50. Air discharged through the second opening 315 may flow backward. For example, the second opening 315 may be formed in the first rear case 311b.

The first blowing module 31 may include a first filter 40. The first filter 40 may be detachably mounted on the filter mounting portion 316. The first filter 40 may be disposed to correspond to the first opening 314. Air passing through the first filter 40 may flow into the first blowing module 31 through the first opening 314.

The first blowing module 31 may include the fan unit 313. The fan unit 313 may generate a blowing force to draw in outside air. The fan unit 313 may form airflow inside the mask 1. The fan unit 313 may be covered by the mask body 10 and the second filter 50.

For example, the fan unit 313 may include the fan 3131 generating blowing force. For example, the fan unit 313 may include a fan case 3132 for accommodating the fan 3131. For example, the fan unit 313 may include a fan driving unit (not shown) provided to drive the fan 3131.

The fan unit 313 may include a communicating portion 3133. The communicating portion 3133 may be formed in the fan case 3132. The communicating portion 3133 may be disposed to correspond to a discharge side of the fan 3131. The communicating portion 3133 may be provided to communicate with the second opening 315. Air discharged from the communicating portion 3133 may flow out of the blowing device 30 through the second opening 315.

The fan unit 313 may be disposed inside the first blowing module 31. The fan unit 313 may be accommodated in the first case 311. The fan unit 313 may be detachably mounted on the fan unit mounting portion 317.

For example, the fan unit mounting portion 317 may include a fixing rib 3171 provided to fix the fan unit 313. The fixing rib 3171 may protrude toward the fan unit 313. The fixing rib 3171 may be provided to fix the outer edge of the fan case 3132.

For example, the fan unit mounting portion 317 may include a fixing protrusion 3172 provided to fix the fan unit 313. The fixing protrusion 3172 may protrude toward the fan unit 313. For example, a fixing hole 3134 formed in the fan case 3132 may be detachably coupled to the fixing protrusion 3172. The fixing hole 3134 of the fan unit 313 may be inserted around the fixing protrusion 3172 of the fan unit mounting portion 317. However, different from that shown in the drawing, the fan case 3132 may include a fixing protrusion, and the fan unit mounting portion 317 may include a fixing hole.

The fan unit 313 may be electrically connected to a controller 323 of the blowing device 30 to be described below. For example, the fan unit 313 may include a wire connected to the controller 323. For example, the wire of the fan unit 313 may pass through the connecting portion 33 and be connected to the controller 323. For example, a wire (not shown) of the fan driving unit may pass through the connecting portion 33 and be connected to the controller 323. Thus, the fan 3131 may be provided to operate in response to an output signal of the controller 323.

The fan unit 313 may be referred to as a fan assembly.

The second blowing module 32 may include a second case 321 forming the external appearance of the second blowing module 32. The second case 321 may be provided to accommodate components of the second blowing module 32.

For example, the second case 321 may include a second front case 321a provided to face the mask body 10. For example, the second case 321 may include a second rear case 321b provided to face a user's face. The second front case 321a and the second rear case 321b may be detachably coupled to each other.

The second case 321 may include an exhaust valve mounting portion 3291 to which an exhaust valve 322 to be described below may be detachably mounted. For example, the exhaust valve mounting portion 3291 may include a hinge coupling portion 3291a to which a hinge 3222 of the exhaust valve 322 is detachably coupled. For example, the exhaust valve mounting portion 3291 may be formed on the second front case 321a. However, it is not limited thereto, and the exhaust valve mounting portion 3291 may be formed in various positions for mounting the exhaust valve 322.

The second case 321 may include a controller mounting portion 3292 to which the controller 323 may be detachably mounted. For example, the controller mounting portion 3292 may be formed on the second front case 321a. However, it is not limited thereto, and the controller mounting portion 3292 may be formed in various positions for mounting the controller 323.

The second case 321 may include a battery mounting portion 3293 in which a battery 324 may be detachably mounted. For example, the battery mounting portion 3293 may be formed on the second front case 321a. However, it is not limited thereto, and the battery mounting portion 3293 may be formed in various positions for mounting the battery 324.

The second case 321 may include an input unit mounting portion 3294 to which the input unit 327 to be described below may be detachably mounted. For example, the input unit mounting portion 3294 may be formed on the second front case 321a. However, it is not limited thereto, and the input unit mounting portion 3294 may be formed in various positions for mounting the input unit 327.

The second blowing module 32 may include a third opening 325 through which air flows into the second blowing module 32. Air between the second filter 50 and a user's face may pass through the second filter 50 and be introduced into the second blowing module 32 through the third opening 325. Air exhausted from a user may pass through the second filter 50 and be introduced into the second blowing module 32 through the third opening 325. The third opening 325 may be formed in the second case 321. For example, the third opening 325 may be formed in the second rear case 321b.

The second blowing module 32 may include a fourth opening 326 through which airflows out of the second blowing module 32. Air passing through the second blowing module 32 may flow toward the mask body 10 through the fourth opening 326. Air flowing out through the fourth opening 326 may pass through the mask body 10 and be discharged to the outside of the mask 1. Air discharged through the fourth opening 326 may flow forward. The fourth opening 326 may be formed in the second case 321. For example, the fourth opening 326 may be formed in the second front case 321a.

The second blowing module 32 may include the exhaust valve 322. The exhaust valve 322 may be provided to open and close the fourth opening 326. For example, the exhaust valve 322 may be provided to open the fourth opening 326 when a user exhales. For example, the exhaust valve 322 may be provided to close the fourth opening 326 when a user inhales. Thereby, the exhaust valve 322 may be provided to prevent backflow of air discharged to the outside. The exhaust valve 322 may only allow air to flow in a discharge direction. For example, the exhaust valve 322 may prevent air discharged by a user from flowing back toward the user. For example, the exhaust valve 322 may only allow forward flow of air. For example, the exhaust valve 322 may be provided as a check valve.

For example, the exhaust valve 322 may include an opening and closing plate 3221. For example, the exhaust valve 322 may include the hinge 3222.

The hinge 3222 may be detachably coupled to the hinge coupling portion 3291a. The opening and closing plate 3221 may be provided to open and close the fourth opening 326 as the hinge 3222 rotates. In a state in which the hinge 3222 is coupled to the hinge coupling portion 3291a, the opening and closing plate 3221 may be provided to rotate upward. For example, the hinge 3222 may be provided on an upper side of the opening and closing plate 3221.

The blowing device 30 may include the controller 323. The controller 323 may be provided to control the operation of the mask 1. The controller 323 may be provided to control the operation of the blowing device 30. For example, the controller 323 may be provided to control the operation of the fan unit 313. For example, the controller 323 may be provided to control the operation of the fan 3131. For example, the controller 323 may be provided to control on/off of the fan 3131. For example, the controller 323 may be provided to control the rotational speed of the fan 3131. For example, the controller 323 may be provided as a printed board assembly (PBA).

For example, the controller 323 may be accommodated in the second case 321. For example, the controller 323 may be detachably mounted on the controller mounting portion 3292. However, it is not limited thereto, and the controller 323 may be accommodated in the first case 321.

The blowing device 30 may include the battery 324. The battery 324 may be provided to supply power to the mask 1. The battery 324 may be provided to supply power to components of the mask 1. For example, the battery 324 may be provided to supply power to the blowing device 30.

For example, the battery 324 may be accommodated in the second case 321. For example, the battery 324 may be detachably mounted on the battery mounting portion 3293. However, it is not limited thereto, and the battery 324 may be accommodated in the first case 321.

The blowing device 30 may include a charging terminal 328. The charging terminal 328 may receive power from the outside. The charging terminal 328 may be provided to charge the battery 324. The charging terminal 328 may be electrically connected to the controller 323.

For example, the charging terminal 328 may be accommodated in the second case 321. For example, the charging terminal 328 may be detachably mounted on the battery mounting portion 3293. However, it is not limited thereto, and the charging terminal 328 may be accommodated in the first case 321.

The blowing device 30 may include the input unit 327. The input unit 327 may be provided to receive a user's command. The input unit 327 may be provided to be electrically connected to the controller 323. The input unit 327 may transmit information received from the user to the controller 323. The controller 323 may control the blowing device 30 based on information transmitted from the input unit 327.

For example, the input unit 327 may include at least one of a button or a display. However, the disclosure is not limited thereto, and the input unit 327 may be provided in various forms for receiving a user's input.

For example, the input unit 327 may be detachably mounted on the second case 321. For example, the input unit 327 may be detachably mounted on the input unit mounting portion 3294. However, the disclosure is not limited thereto, and the input unit 327 may be detachably mounted on the first case 321.

The blowing device 30 may include a connecting portion 33 that connects the first blowing module 31 and the second blowing module 32. The connecting portion 33 may be provided to cover the wire of the blowing device 30. The connecting portion 33 may include a guide passage 33a that is provided to guide the wire of the blowing device 30. For example, the wire of the fan unit 313 may be connected to the controller 323 by passing through the guide passage 33a.

The blowing device 30 may include a filter mounting portion 34 on which the second filter 50 may be detachably mounted. For example, the filter mounting portion 34 may include a first mounting portion 341 formed on the first blowing module 31 and a second mounting portion 342 formed on the second blowing module 32.

For example, the first mounting portion 341 may be detachably coupled to the first blowing device coupling portion 531. For example, the first mounting portion 341 may be formed at a circumference of the second opening 315 of the first blowing module 31. In a state in which in which the first mounting portion 341 is coupled to the first blowing device coupling portion 531 of the second filter 50, air flowing out through the second opening 315 from the first blowing module 31 may flow to the inlet portion 54 of the second filter 50.

For example, the second mounting portion 342 may be detachably coupled to the second blowing device coupling portion 532. For example, the second mounting portion 342 may be formed at a circumference of the third opening 325 of the second blowing module 32. In a state in which the second mounting portion 342 is coupled to the second blower coupling portion 532 of the second filter 50, air flowing out through the outlet portion 55 of the second filter 50 from the space between the second filter 50 and the user's face may flow to the third opening 325 of the second blowing module.

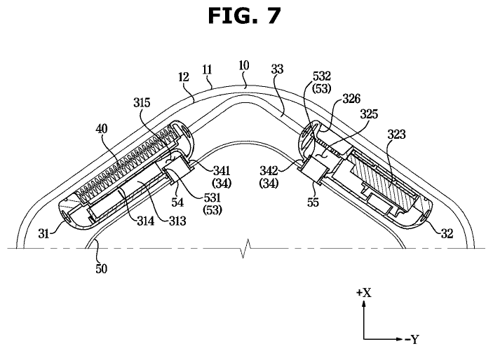

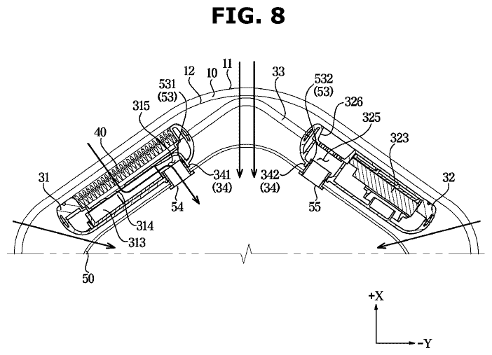

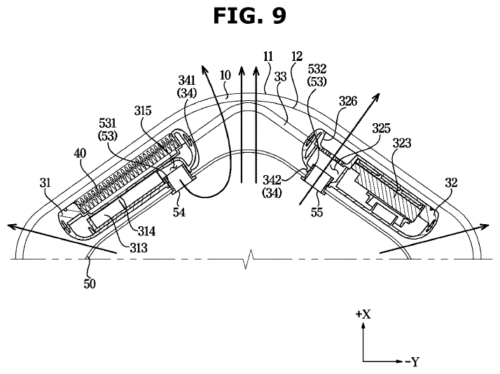

FIG. 7 is a plan view of an example of a mask according to an embodiment of the disclosure. FIG. 8 is a view illustrating airflow during intake of the mask shown in FIG. 7 according to an embodiment of the disclosure. FIG. 9 is a view illustrating airflow during exhaust of the mask shown in FIG. 7 according to an embodiment of the disclosure.

Referring to FIG. 7, the mask 1 may include a mask body 10, a blowing device 30, and at least one filter 40 or 50. The mask 1 may include a mask body 10, a first filter 40, a fan 3131, and a second filter 50. The blowing device 30 may be arranged at the rear of the mask body 10. The second filter 50 may be arranged at the rear of the blowing device 30. The second filter 50 may be arranged at the rear of the first filter 40. The second filter 50 may be arranged at the rear of the fan unit 313. The second filter 50 may be arranged at the rear of the fan 3131. While the mask 1 is worn by the user, the user's face may be located at the rear of the second filter 50.

Referring to FIG. 8, when the user inhales, air outside the mask body 10 may flow toward the user's face by passing through the mask body 10, the first filter 40, the fan 3131, and the second filter 50. The outside air may flow toward the user's face by passing through the mask body 10, the first blowing module 31, and the second filter 50.

When the user inhales, air outside the mask body 10 may flow toward the user's face by passing through the mask body 10 and the second filter 50. That is, the outside air may flow toward the user's face through the mask body 10 and the second filter 50 without passing through the first blowing module 31. The outside air may flow toward the user's face through the mask body 10 and the second filter 50 without passing through the first filter 40 and the fan 3131.

In summary, when the user inhales, outside air may be introduced into the mask 1 by passing through the first blowing module 31. In addition, when the user inhales, outside air may be introduced into the mask 1 without passing through the first blowing module 31. For example, when the amount of air introduced through the first blowing module 31 is insufficient, outside air may be additionally introduced into the mask 1 in response to the user inhaling. In response to the user inhaling, outside air may be introduced into the mask 1 by passing through only the mask body 10 and the second filter 50. Accordingly, it is easy to ensure the amount of air used for the user's breathing. As a result, by maximally ensuring the intake air path of the mask 1, the user may breathe more smoothly.

Referring to FIG. 9, when the user exhales, air between the second filter 50 and the user's face may flow toward the outside of the mask body 10 through the second filter 50, the second blowing module 32, and the mask body 10. When the user exhales, air inside the mask 1 may flow toward the outside of the mask 1 through the second filter 50, the second blowing module 32, and the mask body 10.

When the user exhales, air between the second filter 50 and the user's face may flow toward the outside of the mask body 10 through the second filter 50 and the mask body 10. That is, air inside the mask 1 may flow toward the outside of the mask 1 through the mask body 10 and the second filter 50 without passing through the second blowing module 32.

In summary, when the user exhales, the air inside the mask 1 may flow to the outside of the mask 1 through the second blowing module 32. In addition, when the user exhales, the air inside the mask 1 may flow to the outside of the mask 1 without passing through the second blowing module 32. For example, air not needed for the user's breathing inside the mask 1 may flow directly toward the outside of the mask 1 without passing through the second blowing module 32. In response to the user's exhalation, the air inside the mask 1 may flow to the outside of the mask 1 only by passing through the second filter 50 and the mask body 10. Accordingly, air not needed for the user's breathing may be easily discharged out of the mask 1. As a result, by maximally ensuring the exhaust path of the mask 1, the user may breathe more smoothly.

In the related art, for example, a blowing device is mounted on the mask body to be connected to the outside and inside of the mask, and air may flow only through the blowing device mounted on the mask body. In this case, there is a limitation in ensuring an air intake path and/or an air exhaust path for the mask. During air intake and/or exhaust of the mask, the airflow resistance may increase. In other words, the pressure inside the mask may drastically increase or decrease. In addition, since the blowing device does not operate in consideration of the breathing characteristics of a person, the air intake and exhaust patterns of the blowing device may differ from the actual breathing patterns of a person. As a result, the user may feel discomfort in breathing when wearing the mask.

Referring to FIGS. 8 and 9, the mask 1 may intake or exhaust air in consideration of the user's actual breathing. The mask 1 may intake or exhaust air in response to the user's breathing. Since both the mask body 10 and the second filter 50 are provided to allow air to be introduced and discharged therethrough, the air intake path and/or exhaust path of the mask 1 may be easily ensure. Air may flow not only in the part in which the blowing device 30 of the mask 1 is provided, but also over the entire area of the mask 1. Accordingly, the air may naturally flow in response to the user's breathing, and the airflow resistance may be reduced. In addition, the pressure change inside the mask 1 may be small. As a result, the user may breathe more smoothly when wearing the mask 1. The usability of the mask 1 may be improved.

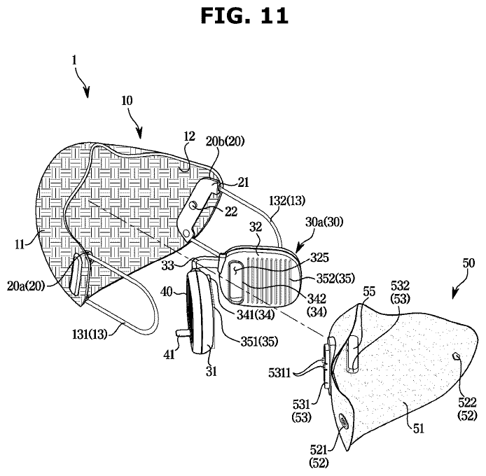

FIG. 10 is an exploded view of an example of a mask according to an embodiment of the disclosure. FIG. 11 is an exploded view of an example of a mask according to an embodiment of the disclosure. The same reference numerals are assigned to the same components as those of the mask 1 shown in FIGS. 1 to 9, and details thereof may be omitted.

Referring to FIGS. 10 and 11, an example of a blowing device may be described. Compared to the blowing device 30 described in FIGS. 3 to 9, a blowing device 30a may further include a spacer. Except for the spacer, the blowing device 30a may include the same configuration as the blowing device 30. For example, the blowing device 30a may include the same configuration as the blowing device 30 shown in FIG. 6. Details of the same configuration may be omitted. In addition, although not shown in FIGS. 10 and 11, the mask 1 may further include a third filter 60 (see FIG. 5).

The blowing device 30a may include a spacer 35. The spacer 35 may be provided on the rear side of the blowing device 30a. The spacer 35 may be formed on the rear case 311b or 321b of the blowing device 30a.

For example, the spacer 35 may protrude rearward (in the −X direction) from the case 311 or 321 of the blowing device 30a. For example, the spacer 35 may protrude from at least one of the first blowing module 31 or the second blowing module 32 toward the second filter 50. For example, the spacer 35 may protrude rearward from at least one of the first blowing module 31 or the second blowing module 32. For example, the spacer 35 may protrude from the rear surface of the blowing device 30a. For example, the spacer 35 may extend from the rear surface of the blowing device 30a toward the second filter 50. For example, the spacer 35 may protrude from the rear surface of the blowing device 30a by about 2 mm to 5 mm. However, the disclosure is not limited to the numerical range, and the protruding length of the spacer 35 may be variously formed depending on the case. For example, when the spacer 35 is provided in plural, the protrusion lengths of each of the plurality of spacers 35 may be provided to be the same or different. For example, the protrusion length of one spacer of the plurality of spacers 35 may be approximately 2 mm, and the protrusion length of another spacer of the plurality of spacers 35 may be approximately 5 mm.

Although not shown in the drawing, for example, the spacer 35 may protrude rearward from the connecting portion 33. For example, the spacer 35 may protrude toward the second filter 50 from the connecting portion 33.

For example, the spacer 35 may include at least one of a first spacer 351 formed on the rear side of the first blowing module 31 or a second spacer 352 formed on the rear side of the second blowing module 32. That is, the spacer 35 may include the first spacer 351. The spacer 35 may include the second spacer 352. The spacer 35 may include both the first spacer 351 and the second spacer 352. For example, the first spacer 351 may protrude from the first rear case 311b toward the second filter 50. For example, the second spacer 352 may protrude from the second rear case 321b toward the second filter 50.

The spacer 35 may be provided to prevent the blowing device 30a and other components of the mask 1 from coming into close contact with each other. The spacer 35 may be provided to ensure a space between the blowing device 30a and other components of the mask 1.

The spacer 35 may be provided to form a gap between the blowing device 30a and the second filter 50. The spacer 35 may be provided to form a path between the blowing device 30a and the second filter 50. The spacer 35 may allow air to flow between the blowing device 30a and the second filter 50. The spacer 35 may be provided to contact the second filter 50. The spacer 35 may be provided to pressurize the second filter 50. The spacer 35 may be provided to push the second filter 50 backward. The air may flow smoothly through a space (a gap or path) formed by the spacer 35.

For example, when a user is breathing while wearing a mask, the blower and the filter may come into close contact with each other. The flow resistance may increase in a part in which the blower and the filter come into close contact. The airflow may not be smooth in the part in which the blower and the filter come into close contact. As a result, an area of the filter through which air may flow may be reduced, and the usability of the filter may be reduced. In other words, the user may feel discomfort when using the mask.

In the disclosure, the spacer 35 may be provided to prevent the blowing device 30a and the second filter 50 from coming into close contact with each other. The spacer 35 may be provided to protrude toward the second filter 50 and push the second filter 50. Accordingly, the second filter 50 may not be stuck to the blowing device 30a. In addition, air may flow smoothly between the blowing device 30a and the second filter 50. Thereby, the efficiency of use of the second filter 50 may not be lowered. The user may breathe smoothly while wearing the mask 1.

The spacer 35 may be referred to as a rib 35. The spacer 35 may be referred to as a protruding portion 35. The spacer 35 may be referred to as a protrusion 33.

Meanwhile, the spacer 35 may not be provided as a component of the blowing device 30a. For example, the spacer 35 may be provided as a separate component from the blowing device 30a and may be detachably coupled to the rear side of the blowing device 30a. For example, the spacer 35 may be provided as a separate component from the blowing device 30a and may be detachably coupled to the front side of the second filter 50. For example, the spacer 35 may be provided as a component of the second filter 50.

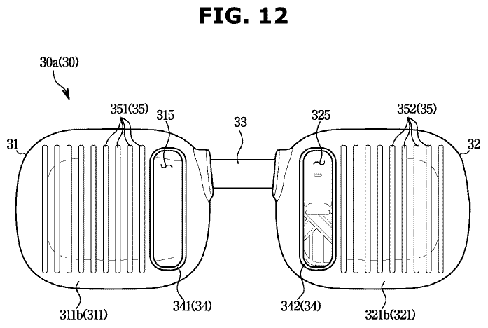

FIG. 12 is a rear view of an example of a blowing device according to an embodiment of the disclosure.

A spacer 35 may have a shape extending approximately in a vertical direction (Z direction). The spacer 35 may have a shape extending approximately in an upper-lower direction (Z direction).

The spacer 35 may be provided in plural. The plurality of spacers 35 may be arranged to be spaced apart by a predetermined interval approximately along the left-right direction (Y direction).

However, different from that shown in FIG. 12, the spacer 35 may be provided as a single configuration. Different from that shown in FIG. 12, the plurality of spacers 35 may be arranged to be spaced apart irregularly. Different from that shown in FIG. 12, the extension lengths of the plurality of spacers 35 may be different. For example, the vertical length of one spacer of the plurality of spacers 35 may be different from the vertical length of another spacer of the plurality of spacers 35.

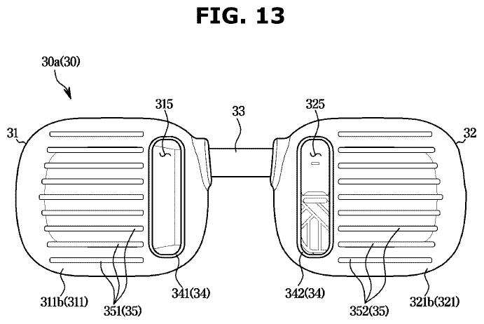

FIG. 13 is a rear view of an example of a blowing device according to an embodiment of the disclosure.

A spacer 35 may have a shape extending approximately in the left-right direction (Y direction).

The spacer 35 may be provided in plural. The plurality of spacers 35 may be arranged to be spaced apart by a predetermined interval approximately along the upper-lower direction (Z direction).

However, different from that shown in FIG. 13, the spacer 35 may be provided as a single configuration. Different from that shown in FIG. 13, the plurality of spacers 35 may be arranged to be spaced apart irregularly. For example, the extended lengths of the plurality of spacers 35 may be the same or different. For example, the length of one spacer of the plurality of spacers 35 along the left-right direction may be different from the length of another spacer of the plurality of spacers 35 along the left-right direction.

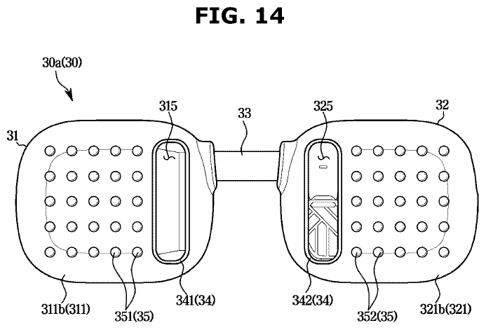

FIG. 14 is a rear view of an example of a blowing device according to an embodiment of the disclosure.

A spacer 35 may have an approximate dot shape. However, the disclosure is not limited thereto, and the spacer 35 may be provided to have various shapes such as a circle, an oval, a polygon, etc.

The spacer 35 may be provided in plural. The plurality of spacers 35 may be arranged in rows and columns. For example, an approximate square pattern may be formed by four adjacent spacers among the plurality of spacers 35. In this case, four spacers may be arranged adjacent to one space on the top, bottom, left, and right of the one spacer, and the distance between the one spacer and the four adjacent spacers may be provided to be approximately the same.

Although not shown in the drawing, for example, one spacer arranged in one row among the plurality of spacers 35 may be arranged in the middle of two spacers belonging to adjacent rows. For example, an approximately equilateral triangle pattern may be formed by three adjacent spacers among the plurality of spacers 35. In this case, six spacers may be arranged adjacent to one spacer, and the distance between the one spacer and the six adjacent spacers may be arranged to be approximately the same.

However, different from that shown in FIG. 14, the spacer 35 may be provided as a single configuration. Different from that shown in FIG. 14, the spacing between the plurality of rows of the plurality of spacers 35 may be provided to be different from the spacing between the plurality of columns. Different from that shown in FIG. 14, the plurality of spacers 35 may be arranged to be irregularly spaced apart.

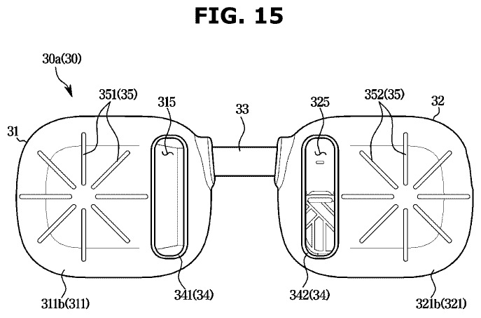

FIG. 15 is a rear view of an example of a blowing device according to an embodiment of the disclosure.

A spacer 35 may be provided in plural. The plurality of spacers 35 may be arranged radially. Each of the plurality of spacers 35 may be arranged radially around an arbitrary point.

Referring to FIG. 15, the extension lengths of each of the plurality of spacers 35 are illustrated as being approximately the same, but the disclosure is not limited thereto. Unlike that shown in FIG. 15, the extension lengths of each of the plurality of spacers 35 may be provided to be different.

The shapes and/or arrangements of the spacers 35 shown in FIGS. 12 to 15 are merely exemplary. The shape and/or arrangement is not limited as long as the spacer 35 can prevent the blowing device 30a and the second filter 50 from being in close contact with each other.

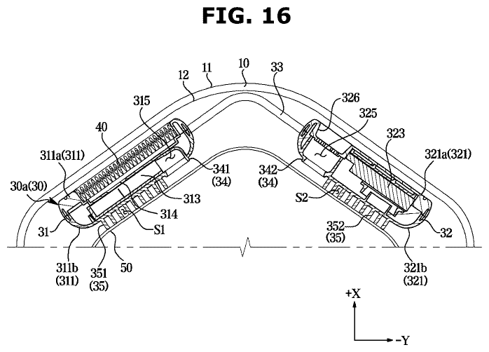

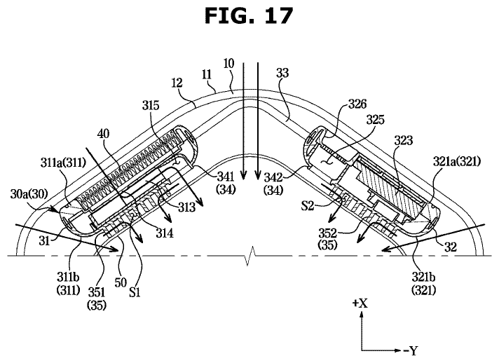

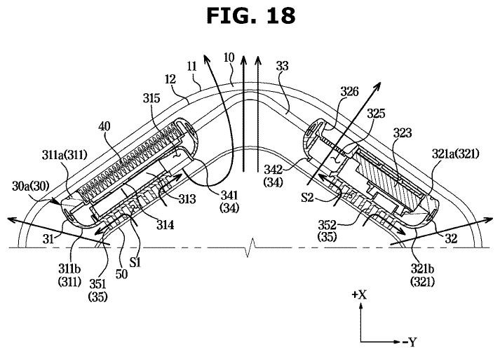

FIG. 16 is a plan view of an example of a mask according to an embodiment of the disclosure. FIG. 17 is a view illustrating airflow during intake of the mask shown in FIG. 16 according to an embodiment of the disclosure. FIG. 18 is a view illustrating airflow during exhaust of the mask shown in FIG. 16 according to an embodiment of the disclosure. In the following description, content having been described with reference to FIGS. 7 to 9 may be omitted.

Referring to FIG. 16, a mask 1 may include a mask body 10, a blowing device 30a, and at least one filter 40 and 50. The mask 1 may include a mask body 10, a fan unit 313, a first filter 40, a second filter 50, and a spacer 35. The mask 1 may include a mask body 10, a fan 3131, a first filter 40, a second filter 50, and a spacer 35. The spacer 35 may be arranged between the fan unit 313 and the second filter 50. The spacer 35 may be arranged between the fan 3131 and the second filter 50. Although not shown in the drawing, the mask 1 may further include a third filter 60.

Referring to FIG. 17, when the user inhales, the outside air may flow toward the user's face through the mask body 10, the first blowing module 31, and the second filter 50. When the user inhales, the outside air may flow toward the user's face through the mask body 10, the fan 3131, and the second filter 50.

When the user inhales, the outside air may flow toward the user's face through the mask body 10 and the second filter 50. That is, the outside air may flow toward the user's face through the mask body 10 and the second filter 50 without passing through the first blowing module 31.

The spacer 35 may be provided to ensure a space between the blowing device 30a and the second filter 50. For example, the first spacer 351 may form a first path S1 between the first blowing module 31 and the second filter 50. For example, the second spacer 352 may form a second path S2 between the second blowing module 32 and the second filter 50. With such a structure, when the user inhales, the outside air may pass through the mask body 10 and then flow into a space between the blowing device 30a and the second filter 50. When the user inhales, the air between the blowing device 30a and the second filter 50 may pass through the second filter 50 and flow toward the user's face. For example, the air that has passed through the mask body 10 may travel through the first path S1 and/or the second path S2 and then pass through the second filter 50.

The spacer 35 may prevent the blowing device 30a and the second filter 50 from being in close contact. As a result, air may flow smoothly between the blowing device 30a and the second filter 50, and the amount of air drawn into the mask when the user inhales may also be increased. As a result, the intake efficiency of the mask may be improved.

Referring to FIG. 18, when the user exhales, air between the second filter 50 and the user's face may flow toward the outside of the mask body 10 through the second filter 50, the second blowing module 32, and the mask body 10. When the user exhales, air inside the mask 1 may flow to the outside of the mask 1 through the second filter 50, the second blowing module 32, and the mask body 10.

When the user exhales, the air between the second filter 50 and the user's face may flow toward the outside of the mask body 10 through the second filter 50 and the mask body 10. That is, the air inside the mask 1 may flow to the outside of the mask 1 through the mask body 10 and the second filter 50 without passing through the second blowing module 32.

The spacer 35 may be provided to ensure a space between the blowing device 30a and the second filter 50. For example, the first spacer 351 may form a first path S1 through which air may flow between the first blowing module 31 and the second filter 50. For example, the second spacer 352 may form a second path S2 through which air may flow between the second blowing module 32 and the second filter 50. With such a structure, when the user exhales, the air inside the mask 1 may flow through the second filter 50 and into the space between the blowing device 30a and the second filter 50. When the user exhales, the air between the blowing device 30a and the second filter 50 may pass through the mask body 10 and be discharged to the outside. For example, the air that has passed through the second filter 50 may travel through the first path S1 and/or the second path S2 and then pass through the mask body 10.

The spacer 35 may prevent the blowing device 30a and the second filter 50 from being in close contact with each other. As a result, the air may smoothly flow between the blowing device 30a and the second filter 50, and the amount of air discharged to the outside of the mask when the user exhales may also be increased. As a result, the discharge efficiency of the mask may be improved.

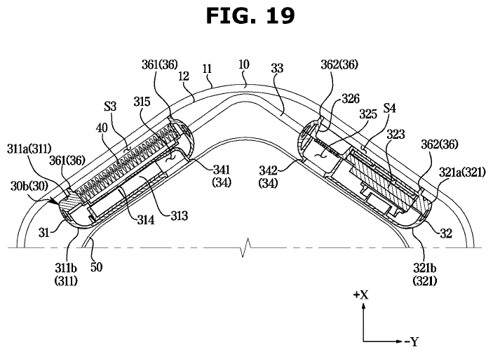

FIG. 19 is a plan view of an example of a mask according to an embodiment of the disclosure.

The same reference numerals are assigned to the same components as those of the mask shown in FIGS. 1 to 18, and detailed descriptions thereof may be omitted. Compared to the blowing device 30a described in FIGS. 10 to 18, a blowing device 30b shown in FIG. 19 may differ only in the arrangement of the spacer. It should be understood that various shapes and/or arrangements of the spacer 35 (see FIGS. 12 to 15 may be applied to a spacer 36.

The blowing device 30b may include the spacer 36. The spacer 36 may be provided on the front side of the blowing device 30b. The spacer 36 may be formed on the front case 311a or 321a of the blowing device 30b.

For example, the spacer 36 may protrude forward (in the +X direction) from the case 311 or 321 of the blowing device 30b. For example, the spacer 36 may protrude from at least one of the first blowing module 31 or the second blowing module 32 toward the mask body 10. For example, the spacer 36 may protrude forward from at least one of the first blowing module 31 or the second blowing module 32. For example, the spacer 36 may protrude from the front surface of the blowing device 30b. For example, the spacer 36 may extend from the front surface of the blowing device 30b toward the mask body 10. For example, the spacer 36 may protrude in a range of about 2 mm to 5 mm from the front surface of the blowing device 30b. However, the disclosure is not limited to the numerical range, and the protrusion length of the spacer 36 may be variously formed depending on the case. For example, when the spacer 36 is provided in plural, the protrusion lengths of each of the plurality of spacers 36 may be provided to be the same or different. For example, the protrusion length of one spacer of the plurality of spacers 36 may be approximately 2 mm, and the protrusion length of another spacer of the plurality of spacers 36 may be approximately 5 mm.

Although not shown in the drawing, for example, the spacer 36 may protrude forward from the connecting portion 33. For example, the spacer 36 may protrude from the connecting portion 33 toward the mask body 10.

For example, the spacer 36 may include at least one of a third spacer 361 formed on the front side of the first blowing module 31, or a fourth spacer 362 formed on the front side of the second blowing module 32. That is, the spacer 36 may include the third spacer 361. The spacer 36 may include the fourth spacer 362. The spacer 36 may include both the third spacer 361 and the fourth spacer 362. For example, the third spacer 361 may protrude from the first front case 311a toward the mask body 10. For example, the fourth spacer 362 may protrude from the second front case 321a toward the mask body 10.

The spacer 36 may be provided to prevent the blowing device 30b and other components of the mask 1 from coming into close contact with each other. The spacer 36 may be provided to ensure a space between the blowing device 30b and other components of the mask 1.

The spacer 36 may be provided to form a gap between the blowing device 30b and the mask body 10. The spacer 36 may be provided to form a path between the blowing device 30b and the mask body 10. The spacer 36 may allow air to flow between the blowing device 30b and the mask body 10. The spacer 36 may be provided to contact the mask body 10. The spacer 36 may be provided to pressurize the mask body 10. The spacer 36 may be provided to push the mask body 10 forward. Air may flow smoothly through a space (gap or path) formed by the spacer 36.

For example, when the user is breathing while wearing a mask, a blower and a mask body may be in close contact with each other. The flow resistance may increase in a part in which the blower and the mask body are in close contact with each other. The air flow may not be smooth in the part in which the blower and the mask body are in close contact with each other. As a result, an area of the mask body through which an air may flow is reduced, and the usability of the mask body may be reduced. In other words, the user may feel uncomfortable when using the mask.

In the disclosure, the spacer 36 may be provided to prevent the blowing device 30b and the mask body 10 from being in close contact with each other. The spacer 36 may be provided to protrude toward the mask body 10 and push the mask body 10. Accordingly, the mask body 10 may not be stuck to the blowing device 30b. In addition, air may flow smoothly between the blowing device 30b and the mask body 10. Accordingly, the usability of the mask body 10 may not be lowered. The user may breathe smoothly while wearing the mask 1.

The spacer 36 may be referred to as a rib 36. The spacer 36 may be referred to as a protruding portion 36. The spacer 36 may be referred to as a protrusion 36.

The spacer 35 may be referred to as a rear spacer 35, and the spacer 36 may be referred to as a front spacer 36.

Meanwhile, the spacer 36 may not be provided as a component of the blowing device 30b. For example, the spacer 36 may be provided as a component separate from the blowing device 30b and may be detachably coupled to the front side of the blowing device 30b. For example, the spacer 36 may be provided as a component separate from the blowing device 30b and may be detachably coupled to the rear side of the mask body 10. For example, the spacer 36 may be provided as a component of the mask body 10.

The spacer 36 may be provided to ensure a space between the blowing device 30b and the mask body 10. The spacer 36 may prevent the blowing device 30b and the mask body 10 from being in close contact with each other. For example, the third spacer 361 may form a third path S3 through which air may flow between the first blowing module 31 and the mask body 10. For example, the fourth spacer 362 may form a fourth path S4 through which air may flow between the second blowing module 32 and the mask body 10.

As a result, air may flow smoothly between the blowing device 30b and the mask body 10. When the user inhales, the amount of air introduced into the mask may increase as the air may flow through the third path S3 and/or the fourth path S4. When the user exhales, the amount of air discharged out of the mask may increase as the air may flow through the third path S3 and/or the fourth path S4. As a result, the intake and/or discharge efficiency of the mask may be improved, and the user may easily maintain breathing even while wearing the mask.

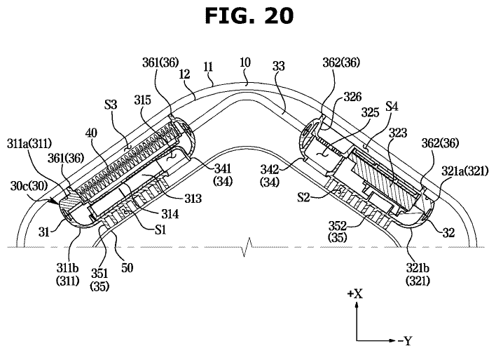

FIG. 20 is a plan view of an example of a mask according to an embodiment of the disclosure.

The same reference numerals are assigned to the same components as those of the mask shown in FIGS. 1 to 19, and detailed descriptions may be omitted. Compared with the blowing device 30a described in FIGS. 10 to 18, a blowing device 30c described in FIG. 20 may further include a spacer 36. Compared with the blowing device 30b described in FIG. 19, the blowing device 30c described in FIG. 20 may further include a spacer 35. It should be understood that various shapes and/or arrangements of the spacer 35 (see FIGS. 12 to 15 may be applied to the spacer 36.

The blowing device 30c may include a rear spacer 35 provided to prevent contact between the blowing device 30c and the mask body 10, and a front spacer 36 provided to prevent contact between the blowing device 30c and the second filter 50.

The rear spacer 35 may be provided on the rear side of the blowing device 30c. The rear spacer 35 may be provided to protrude toward the second filter 50. The rear spacer 35 may be provided to contact the second filter 50.

The front spacer 36 may be provided on the front side of the blowing device 30c. The front spacer 36 may be arranged to protrude toward the mask body 10. The front spacer 36 may be arranged to come into contact with the mask body 10.

For example, the blowing device 30c may include at least one of a first spacer 351 formed on the rear side of the first blowing module 31, a second spacer 352 formed on the rear side of the second blowing module 32, a third spacer 361 formed on the front side of the first blowing module 31, or a fourth spacer 362 formed on the front side of the second blowing module 32.

For example, the mask may include at least one of a first path S1 formed between the first blowing module 31 and the second filter 50, a second path S2 formed between the second blowing module 32 and the second filter 50, a third path S3 formed between the first blowing module 31 and the mask body 10, or a fourth path S4 formed between the second blowing module 32 and the mask body 10. Air may be provided to flow through the first path S1, the second path S2, the third path S3, and/or the fourth path S4.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A mask comprising:
a mask body allowing air to be introduced and discharged therethrough;
a fan disposed at a rear of the mask body to generate a blowing force;
a first filter disposed between the mask body and the fan, and configured to filter air intaken by the fan; and
a second filter disposed at a rear of the fan to cover at least a part of a face of a user,
wherein the second filter is configured to:
filter air intaken from an outside of the mask body when the user inhales, and
filter air discharged toward the outside of the mask body when the user exhales.

2. The mask of claim 1, further comprising:
a suction module including the first filter and the fan; and
a discharge module configured to discharge air passed through the second filter to the outside of the mask body.

3. The mask of claim 1, wherein when the user inhales, air outside of the mask body is allowed to:
flow toward the face of the user by passing through the mask body, the first filter, the fan, and the second filter, and
flow toward the face of the user by passing through the mask body and the second filter.

4. The mask of claim 2, wherein when the user exhales, air between the second filter and the face of the user is allowed to:
flow toward the outside of the mask body by passing through the second filter, the discharge module, and the mask body, and
flow toward the outside of the mask body by passing through the second filter and the mask body.

5. The mask of claim 1, wherein the mask body is flexible.

6. The mask of claim 2, further comprising:
an exhaust valve configured to allow an airflow toward the outside of the mask body.

7. The mask of claim 1, wherein the first filter and the fan are covered by the mask body and the second filter.

8. The mask of claim 2,
wherein the suction module further includes an opening through which air passed through the first filter and the fan is discharged, and
wherein the second filter further includes an inlet portion provided to correspond to the opening of the suction module and provided to receive the air discharged through the opening of the suction module.

9. The mask of claim 8,
wherein the suction module further includes a filter mounting portion formed along a circumference of the opening, and
wherein the second filter further includes a coupling portion detachably coupled to the filter mounting portion of the suction module.

10. The mask of claim 2,
wherein the discharge module further includes an opening through which air passed through the second filter is introduced, and
wherein the second filter further includes an outlet portion provided to correspond to the opening of the discharge module and provided to discharge air toward the opening of the discharge module.

11. The mask of claim 10,
wherein the discharge module further includes a filter mounting portion formed along a circumference of the opening, and
wherein the second filter further includes a coupling portion detachably coupled to the filter mounting portion of the discharge module.

12. The mask of claim 1, wherein the mask body includes a fabric material.

13. The mask of claim 1, wherein the second filter is configured to block droplets.

14. The mask of claim 2, further comprising:
a blowing device disposed between the mask body and the second filter, and including the suction module and the discharge module,
wherein the blowing device includes a spacer protruding rearward from at least one of the suction module or the discharge module to prevent the blowing device and the second filter from being in close contact with each other.

15. The mask of claim 14, wherein the spacer is configured to form a path through which air is allowed to flow between the blowing device and the second filter.
